(19) United States
(12) Patent Application Publication
(10) Pub. No.: US 2019/0134729 A1
(43) Pub. Date: May 9, 2019

(54) SHAPE-TUBE ELECTROCHEMICAL MACHINING (STEM) SYSTEMS AND METHODS OF FORMING CURVED HOLES IN COMPONENTS USING STEM SYSTEMS

(71) Applicant: General Electric Company, Schenectady, NY (US)

(72) Inventors: Eric Alan Overholt, Bath, PA (US); Jerzy Owczarek, Hackettstown, NJ (US)

(21) Appl. No.: 15/805,657

(22) Filed: Nov. 7, 2017

(51) Int. Cl. B23H 7/26; B23H 9/10; B23H 3/06; B23H 9/14

(52) U.S. Cl. CPC B23H 7/265; B23H 9/10; B23H 5/04; B23H 9/14; B23H 3/06

(57) ABSTRACT

Shape-tube electrochemical machining (STEM) systems, and methods of forming curved holes in components using STEM systems are disclosed. The systems may include a slider element, and an electrode coupled to the slider element. The electrode may include a linear body section, and a tip section. The tip section may be angled at a non-linear angle relative to the linear body section. The systems may also include a guide block slidably engaging the electrode. The guide block may include at least one aperture formed between a first and second section. The aperture(s) may receive the electrode. Additionally, the systems may include an electrode positioning block coupled to the linear body section of the electrode. The electrode positioning block may position the tip section of the electrode at a desired orientation relative to a component receiving the tip section to form a curved hole in the component.

### BACKGROUND OF THE INVENTION

The disclosure relates generally to shape-tube electrochemical machining (STEM), and more particularly, to STEM systems and methods of forming curved holes in components using STEM systems.

Gas turbine systems are one example of turbomachines widely utilized in fields such as power generation. A conventional gas turbine system includes a compressor section, a combustor section, and a turbine section. During operation of a gas turbine system, various components in the system, such as turbine blades and nozzle airfoils, are subjected to high temperature flows, which can cause the components to fail. Since higher temperature flows generally result in increased performance, efficiency, and power output of a gas turbine system, it is advantageous to cool the components that are subjected to high temperature flows to allow the gas turbine system to operate at increased temperatures.

An airfoil for a turbine blade typically contains an intricate maze of internal cooling channels. Cooling air (or other suitable coolant) provided by, for example, a compressor of a gas turbine system, may be passed through and out of the cooling channels to cool various portions of the multi-wall airfoil and/or turbine blade. However, forming these cooling channels within turbine blades using conventional systems and/or processes can be difficult and may result in negatively affecting other characteristics (e.g., operational life) of the turbine blades. For example, cooling channels may be formed in turbine blades by conventional material removal processes, such as drilling. However, if the drill is not properly aligned or calibrated, the cooling channel formed in the turbine blade may include an undesirable shape, geometry and/or may be formed in an undesirable location within the turbine blade. That is, if a drill forming a cooling channel extending to a trailing edge of the turbine blade is not properly aligned or calibrated, and the cooling channel is formed undesirably closer to a pressure side, rather than equidistant between the pressure side and the suction side of the blade, the structural characteristics of the blade may be negatively impacted. Specifically in this example, the material thickness between the pressure side of the blade and the cooling channel formed in the blade may be less than desired or required, and that portion of the blade may be structurally weakened, which in turn may decrease the operational life of the turbine blade.

Additionally, the last stage turbine blades of the system are typically larger in size and include non-linear geometries. For example, the last stage turbine blades may include airfoils that are circumferentially swept to improve operational efficiencies of the turbine blades. Because of the circumferential sweep of the airfoils, the last stage turbine blades may require cooling channels which are curved and/or contour with the circumferential sweep of the airfoil in order to cool the turbine blade. As such, conventional material removal processes, which are typically configured to form linear cooling channels, may not be capable of forming the curved cool channels required by the airfoils.

### BRIEF DESCRIPTION OF THE INVENTION

A first aspect of the disclosure provides a shaped-tube electrochemical machining (STEM) system, including: a slider element; an electrode coupled to and extending from the slider element, the electrode including: a linear body section, and a tip section formed at a distal end of the electrode, adjacent the body section, the tip section angled at a non-linear angle relative to the linear body section; a guide block slidably engaging the linear body section of the electrode, the guide blocking including: a first section, a second section releasably coupled to the first section, and at least one aperture formed between the first section and the second section, the at least one aperture receiving the linear body section of the electrode; and an electrode positioning block coupled to the linear body section of the electrode between the slider element and the guide block, the electrode positioning block positioning the tip section of the electrode at a desired orientation relative to a component receiving the tip section of the electrode to form a curved hole in the component.

A second aspect of the disclosure provides a method of forming a curved hole in a component using a shaped-tube electrochemical machining (STEM) system. The method includes: coupling an electrode positioning block of the STEM system to a linear body section of an electrode, the electrode including: the linear body section, and a tip section formed at a distal end of the electrode, adjacent the linear body section, the tip section angled at a non-linear angle relative to the linear body section; coupling the electrode of the STEM system to a slider element of the STEM system; positioning the linear body section of the electrode through an aperture of a guide block of the STEM system, the guide block positioned adjacent the electrode positioning block and opposite the slider element; positioning the tip section of the electrode at a desired orientation relative to the component using the electrode positioning block; and traversing the tip section of the electrode through the component to form the curved hole within the component during operation of the electrode of the STEM system.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a linear tip section of an electrode for a shaped-tube electrochemical machining (STEM) system, according to embodiments of the disclosure.

FIG. 2 shows an angled tip section of an electrode for a STEM system, according to embodiments of the disclosure.

FIG. 3 shows a curved tip section of an electrode for a STEM system, according to embodiments of the disclosure.

FIG. 4 shows an exploded, perspective view of a STEM system including an electrode with an angled tip section, according to embodiments of the disclosure.

FIG. 5 shows a perspective view of the STEM system of FIG. 4, according to embodiments of the disclosure.

FIG. 6 shows a perspective view of a guide block of a STEM system, according to embodiments of the disclosure.

FIG. 7 shows a perspective view of a component including a curved hole formed using a STEM system, according to embodiments of the disclosure.

FIG. 8 shows a flow chart of an example process for forming a curved hole in a component using a STEM system, according to embodiments of the disclosure.

FIGS. 9 and 10 show perspective views of a STEM system performing a process of forming a curved hole in a component, according to embodiments of the disclosure.

FIGS. 11 and 12 show perspective views of a component undergoing processes for forming a curved hole therein using a STEM system, according to embodiments of the disclosure.

FIG. 13 shows a perspective view of a component including a curved hole, according to additional embodiments of the disclosure.

FIGS. 14 and 15 show perspective views of a component undergoing processes of forming a hole including a linear portion and a curved portion, according to embodiments of the disclosure.

FIGS. 16-18 show perspective views of a component undergoing processes of forming a hole including two distinct linear portions and a curved portion formed therebetween, according to embodiments of the disclosure.

FIG. 19 shows a perspective view of a component including a linear hole and a distinct hole including a linear portion and a curved portion in communication with the linear portion and the linear hole, according to embodiments of the disclosure.

FIG. 20 shows a perspective view of a component including a plurality of holes including a linear portion and two distinct curved portions branching from the linear portion, according to embodiments of the disclosure.

FIG. 21 shows a perspective view of a component including a curved hole, according to another embodiment of the disclosure.

FIG. 22 shows a perspective view of a component and a hole including a linear portion and a curved portion, according to embodiments of the disclosure. Additionally, FIG. 22 shows an insert including a magnified view of a segment of the curved portion of the hole formed in the component.

FIG. 23 shows a perspective of a component including a linear hole and two distinct curved holes in communication within the linear hole, according to embodiments of the disclosure.

FIG. 24 shows a perspective view of a STEM system including an electrode with an angled tip section, according to additional embodiments of the disclosure.

FIG. 25 shows a perspective view of a turbine blade including a plurality of holes formed therein, according to embodiments of the disclosure.

FIG. 26 shows a side view of a stator vane including a plurality of holes formed therein, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The following disclosure relates generally to shape-tube electrochemical machining (STEM), and more particularly, to STEM systems and methods of forming curved holes in components using STEM systems.

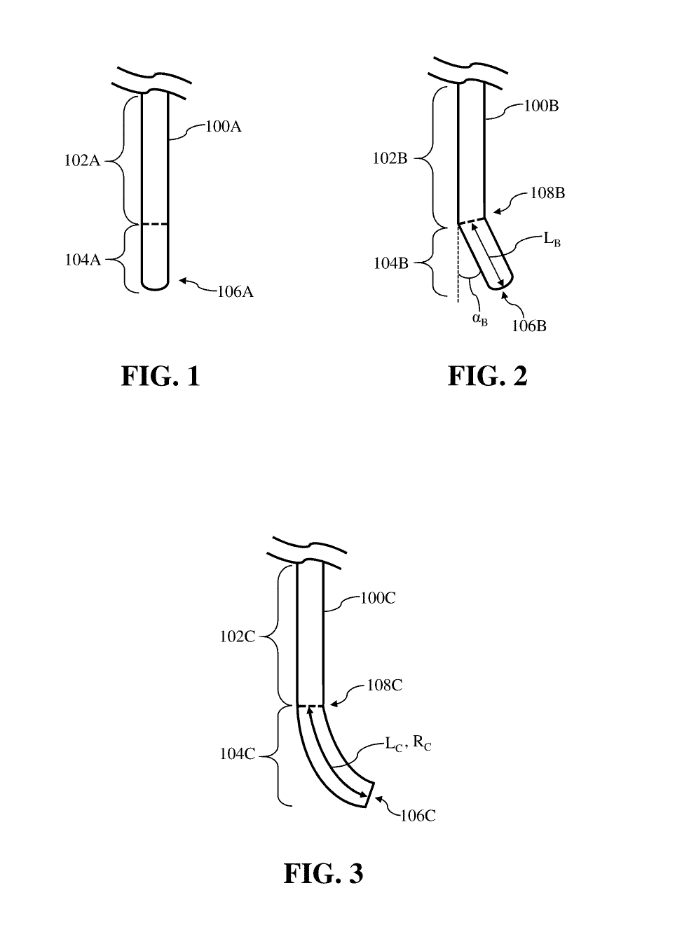

These and other embodiments are discussed below with reference to FIGS. 1-26. However, those skilled in the art will readily appreciate that the detailed description given herein with respect to these Figures is for explanatory purposes only and should not be construed as limiting.

Turning to FIGS. 1-3, a portion of a plurality of electrodes of a shaped-tube electrochemical machining (STEM) system are shown. Specifically, FIG. 1 shows a portion of an electrode including a linear tip section, FIG. 2 shows a portion of an electrode including an angled tip section, and FIG. 3 shows a portion of an electrode including a curved tip section. As discussed herein, each electrode shown in FIGS. 1-3 may be interchangeable with one another within a STEM system, and may be utilized to form curved holes within a component.

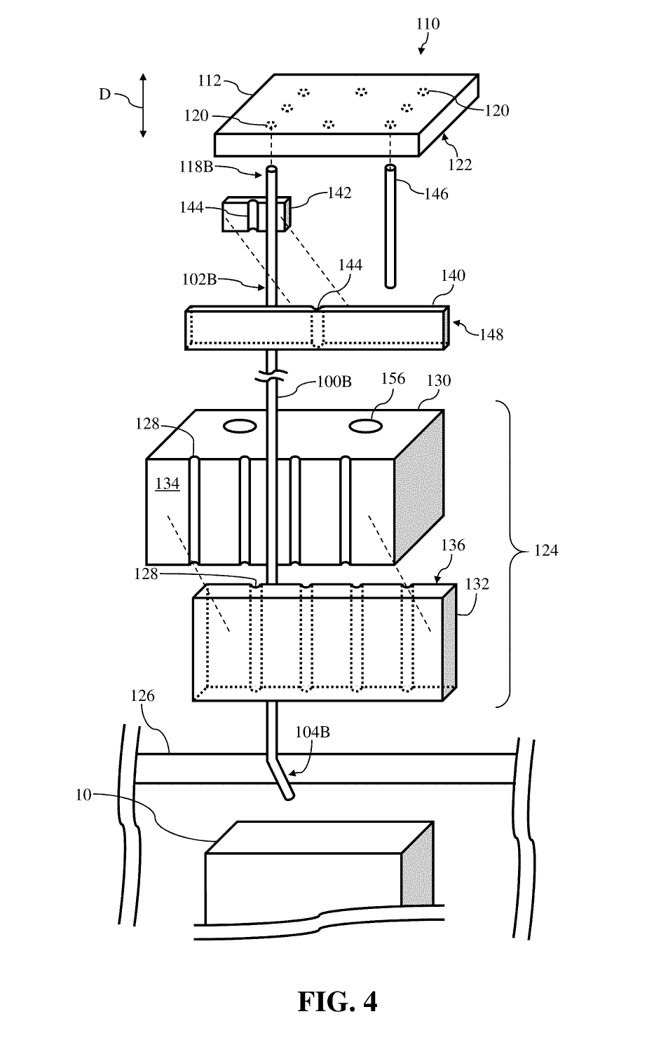

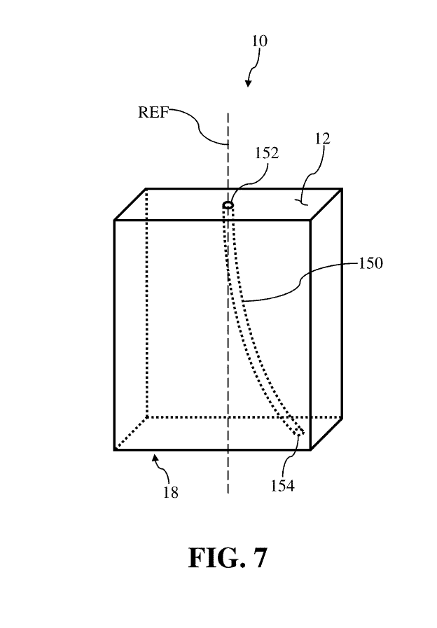

Each of the electrodes 100A, 100B, 100C shown in FIGS. 1-3 may include a linear body section 102A, 102B, 102C, and a tip section 104A, 104B, 104C formed adjacent the linear body section 102A, 102B, 102C. Linear body section 102A, 102B, 102C of electrodes 100A, 100B, 100C may be substantially linear and/or substantially planar. As discussed herein linear body section 102A, 102B, 102C of electrode 100A, 100B, 100C may be coupled to, affixed to, extend from, and/or utilized by a STEM system (see, FIG. 4) for forming at least one hole within a component (see, FIG. 7). As shown in FIGS. 1-3, tip section 104A, 104B, 104C may be formed at a distal end 106A, 106B, 106C of electrode 100A, 100B, 100C and/or linear body section 102A, 102B, 102C, and/or may extend from linear body section 102A, 102B, 102C. Electrodes 100A, 100B, 100C may be formed as any suitable electrode, electrode assembly, and/or electrode system that may be configured to emit electrical discharges and/or perform electrolytic material removal processes to form hole(s) within a component (see, FIG. 7), as discussed herein.

FIG. 1 shows electrode 100A with a linear tip section 104A. Specifically, tip section 104A of electrode 100A shown in FIG. 1 may be substantially linear, non-angled, non-curved, and/or may be linearly aligned with linear body section 102A of electrode 100A. In a non-limiting example, both linear body section 102A and tip section 104A may be formed from a substantially rigid material including, but not limited to, metal, metal alloys, polymers, ceramics and the like. In another non-limiting example, and as similarly discussed herein with respect to electrodes 100B, 100C, tip section 104A of electrode 100A may be formed from a different material (see, phantom line) and/or may have distinct material properties and/or characteristics than a material forming linear body section 102A. As discussed herein, electrode 100A may be utilized to form substantially straight or linear holes and/or recesses within a component using a STEM system.

FIGS. 2 and 3 show electrodes 100B, 100C with substantially angled tip sections 104B, 104C. For example, FIG. 2 shows electrode 100B including tip section 104B angled at a non-linear angle and/or a non-planar angle relative to linear body section 102B. Specifically, electrode 100B may include a deviation or bend 108B (hereafter, “bend 108B”) to form and/or position tip section 104B at a non-linear angle (α_{B}) relative to linear body section 102B of electrode 100B. In the non-limiting example shown in FIG. 2, tip section 104B may be substantially linear (e.g., not curved). As a result, the non-linear angle (α_{B}) of tip section 104B relative to linear body section 102B may be substantially constant and/or uniform. As shown in FIG. 2, tip section 104B of electrode 100B may be formed with and/or may include a predetermined length (L_{B}) and a predetermined non-linear angle (α_{B}) relative to linear body section 102B. The predetermined length (L_{B}) and predetermined non-linear angle (α_{B}) of tip section 104B of electrode 100B may be based on a desired curvature geometry (e.g., length, curve angle, and so on) for the substantially curved hole formed in the component using electrode 100B, as discussed herein.

Linear body section 102B and tip section 104B of electrode 100B may be formed from the same material, different materials (see, phantom line), and/or may have distinct material properties and/or characteristics. In one non-limiting example, linear body section 102B and tip section 104B may be formed from and/or as a titanium tube with a polymer coating substantially covering the titanium tube. In another non-limiting example, tip section 104B may be formed from a rigid material and/or a material that is substantially rigid, such that the predetermined length (L_{B}) and predetermined non-linear angle (α_{B}) of tip section 104B is unchanged and/or unaltered when forming a substantially curved hole(s) in a component, as discussed herein. Conversely, linear body section 102B of electrode 100B may be formed from a substantially flexible and/or elastic material. As a result, linear body section 102B may bend, flex, and/or contour as electrode 100B, and specifically tip section 104B and linear body section 102B, is fed through the component when forming the substantially curved hole within the component, as discussed herein. In an additional non-limiting example, both linear body section 102B, and tip section 104B of electrode 100B may be formed from a substantially elastic material. In this non-limiting example, the elastic material may maintain its shape (e.g., predetermined length (L_{B})/predetermined non-linear angle (α_{B}) of tip section 104B) when the elastic material forming linear body section 102B and tip section 104B of electrode 100B does not experience an outside or auxiliary force (e.g., linear body section 102B moving through the substantially curved hole formed in the component).

In the non-limiting example shown in FIG. 3, electrode 100C may also include bend 108C to form and/or position tip section 104C at a non-linear angle, curvature, and/or radius (R_{C}) (hereafter, “radius (R_{C})”) relative to linear body section 102C of electrode 100C. Distinct from tip section 104B of electrode 100B, tip section 104C shown in FIG. 3 may be substantially curved, arched, rounded, and/or non-linear. As a result, the radius (R_{C}) of tip section 104C relative to linear body section 102C may be substantially variable and/or may increase in tip section 104C when moving from linear body section 102C to distal end 106C. Similar to tip section 104B, and as shown in FIG. 3, tip section 104C of electrode 100C may include a predetermined length (L_{C}), and a predetermined non-linear angle, arc, curvature, and/or radius (R_{C}) that may be based on a desired curvature geometry for the substantially curved hole formed in the component using electrode 100C. The predetermined length (L_{C}) may be the measurable distance between the end of the linear body section 102C and distal end 106C of electrode 100C. Similarly, the predetermined radius (R_{C}) may be the measurable curvature or radius of curvature between the end of the linear body section 102C and distal end 106C of electrode 100C. Similar to tip section 104B of electrode 100B, linear body section 102C and tip section 104C of electrode 100C may be formed from similar material, or alternatively, may be formed from different materials and/or may have distinct material properties and/or characteristics (e.g., rigid materials and elastic materials).

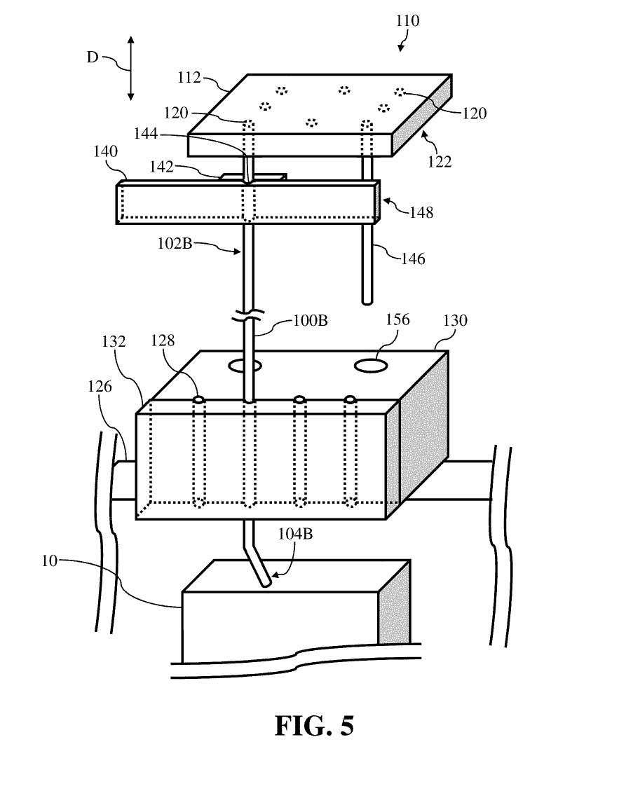

FIGS. 4 and 5 show perspective views of a shaped-tube electrochemical machining (STEM) system that may utilize electrodes 100A, 100B, 100C of FIGS. 1-3 to form a substantially curved hole(s) in a component. Specifically, FIG. 4 shows an exploded, perspective view of STEM system 110 including electrode 100B, and FIG. 5 shows an assembled, perspective view of STEM system 110 including electrode 100B. It is understood that similarly numbered and/or named components may function in a substantially similar fashion. Redundant explanation of these components has been omitted for clarity.

STEM system 110 may include a slider element 112. Slider element 112 may be positioned adjacent to electrode 100B of STEM system 110. As shown in FIGS. 4 and 5, electrode 100B of STEM system 100 may be coupled to, affixed to, and/or may extend from slider element 112 toward a component 10 that may receive electrode 100B to form a substantially curved hole therein. That is, a distinct distal end 1112 of electrode 100B may be positioned through, coupled to, and/or affixed within any of a plurality of openings 120 formed at least partially through a surface 122 of slider element 112. In the non-limiting example, slider element 112 may be a movable plate(s) that may be configured to receive and/or be coupled to electrode 100B and move electrode 100B within STEM system 110. Specifically, slider element 112 may be configured to move in a direction (D) with STEM system 110, which in turn, may also move electrode 100B coupled to slider element 112 in the direction (D). Moving electrode 100B in the direction (D) may allow electrode 100B to pass through component 10 to form a substantially curved hole in component 10, as discussed herein. Slider element 112 may be moved in the direction (D) using any suitable apparatus or system, for example, a hydraulic/actuator system, electric system, manual system (not shown).

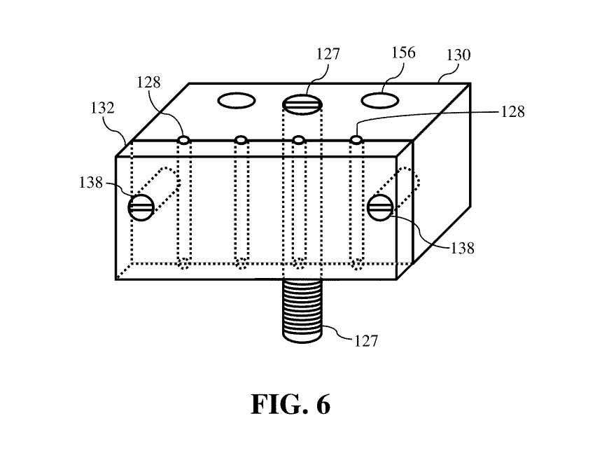

Briefly turning to FIG. 6, and with continued reference to FIGS. 4 and 5, STEM system 110 may also include a guide block 124. A shown in FIGS. 4 and 5, guide block 124 may be positioned between slider element 112 of STEM system 110 and component 10, that latter of which is received by, held in place, and/or positioned within a component fixture 126 of STEM system 10. That is, guide block 124 may be positioned between slider element 112 and component fixture 126 holding component 10, and may be coupled to, affixed to, and/or positioned above component fixture 126. Guide block 124 may be coupled to component fixture 126 using any suitable coupling component and/or coupling technique. As shown in the non-limiting example of FIG. 6, guide block 124 may include a threaded bolt, screw or fastener 127 that may pass through guide block 124 and couple guide 124 block to component fixture 126 (see, FIG. 5).

Guide block 124 may slidably engage linear body section 102B of electrode 100B. Specifically, guide block 124 may include at least one aperture 128 (see, FIGS. 4 and 5) formed therein that may be aligned with and/or may receive linear body section 102B of electrode 100B. As a result, and as shown in FIGS. 4 and 5, guide block 124 may be positioned adjacent (e.g., above), but may not contact or receive, tip section 104B of electrode 100B. Additionally as shown in the non-limiting examples of FIGS. 4 and 5, tip section 104B of electrode 100B may be positioned between guide block 124 and component 10/component fixture 126.

Aperture(s) 128 of guide block 124 may be substantially linear and/or co-planar with linear body section 102B of electrode 100B. Additionally, aperture(s) 128 may be sized and/or may include a diameter that is minimally larger (e.g., approximately 1 millimeter to 5 millimeters) than the diameter of linear body section 102B of electrode 100B. Forming aperture(s) 128 to include a diameter that is minimally larger than the diameter of linear body section 102B may ensure that linear body section 102B of electrode 100B may slidably engage and/or move through aperture(s) 128 of guide block 124 when forming a substantially curved hole within component 10, as discussed herein. Furthermore, forming aperture(s) 128 to include a diameter that is minimally larger than the diameter of linear body section 102B may ensure that linear body section 102B does not undesirably displaced and/or move side-to-side within aperture(s) 128 when forming the substantially curved hole in component 10.

As a result of aperture(s) 128 of guide block 124 being formed to include a diameter that is minimally larger than the diameter of linear body section 102B, guide block 124 must be configured to slidably engage linear body section 102B of electrode 100B without requiring tip section 104B of electrode 100B to pass through aperture(s) 128 of guide blocks 124. That is, where the electrode (e.g., electrode 100B) utilized by STEM system 110 to form a curved hole in component 10 includes a tip section (e.g., tip section 104B) that is angled relative to linear body section (e.g., linear body section 102B), guide block 124 must allow linear body section 102B of electrode 100B to slidably engage and/or be positioned within aperture(s) 128 without passing the tip section through aperture(s) 128. This is because, for example, if angled tip section 104B is attempted to be passed through aperture(s) 128 of guide block 124, angled tip section 104B may not fit due to the predetermined length (L), predetermined non-linear angle (as), and/or the non-linear configuration of tip section 104B and the linear configuration of aperture(s) 128. Alternatively, passing angled tip section 104B of electrode 100B may undesirably displace or deform the predetermined non-linear angle (as) of tip section 104B, which in turn may affect the geometry of the substantially curved hole formed in component 10, as discussed herein.

In one non-limiting example distinct distal end 1112 of electrode 100B may pass through aperture(s) 128 of guide block 124 before distal end 1112 is coupled to slider element 112 of STEM system 110. In this non-limiting example, distal end 1112 may pass through aperture(s) 128 to slidably engage linear body section 102B of electrode 100B with guide block 124/aperture(s) 128 without requiring angled tip section 104B to pass through linear aperture(s) 128.

In another non-limiting example as shown in FIGS. 4-6, guide block 124 may include a plurality of sections. Specifically, guide block 124 may include a first section 130, and a second section 132 releasably coupled to first section 130. In the non-limiting example, respective contact surfaces 134, 136 (see, FIG. 4) for each of first section 130 and second section 132 may include a portion of aperture(s) 128. As a result, when second section 132 is coupled to first section 130, and the respective contact surfaces 134, 136 of first section 130 and second section 132 contact one another, aperture(s) 128 is formed within and/or through guide block 124. Forming guide block 124 to include first section 130 and second section 132, and aperture(s) 128 formed therebetween, allows guide block 124, and more specifically aperture(s) 128, to be positioned/clamped around, and/or slidably engage linear body section 102B of electrode 100B directly. Second section 132 may be releasably coupled to first section 130 to form guide block 124 using any suitable coupling component and/or coupling technique. As shown in the non-limiting example of FIG. 6, a bolt, screw, or fastener 138 may be positioned through second section 132 and at least a portion of first section 130 to releasably couple second section 132 to first section 130 of guide block 124.

Returning to FIGS. 4 and 5, STEM system 110 may also include an electrode positioning block 140 (hereafter, “positioning block 140”). Positioning block 140 may be coupled to and/or affixed to linear body section 102B of electrode 100B. More specifically, and as shown in FIGS. 4 and 5, positioning block 140 may be coupled to and/or affixed to linear body section 102B of electrode 100B between slider element 112 and guide block 124. Positioning block 140 may be coupled to and/or affixed to linear body section 102B such that positioning block 140 does not move, slidably engage and/or traverse linear body section 102B when forming a substantially curved hole in component 10, as discussed herein. In the non-limiting example shown in FIGS. 4 and 5, positioning block 140 may be coupled to and/or affixed to linear body section 102B by positioning and/or clamping a portion of linear body section 102B between positioning block 140 and a back plate 142, and coupling positioning block 140 to back plate 142. To aid in coupling and/or affixing positioning block 140 to linear body section 102B, positioning block 140 and back plate 142 may each include a portion of an aperture 144 configured to receive linear body section 102B, as similarly discussed herein with respect to aperture(s) 128 of guide block 124. However distinct from aperture(s) 128, apertures 144 formed between positioning block 140 and back plate 142 may be sized and/or include a diameter that is substantially equal or less than the diameter of linear body section 102B to ensure positioning plate 140 remains affixed to linear body section 102B, as discussed herein.

STEM system 110 may also include electrode positioning pin 146 (hereafter, “positioning pin 146”). As shown in FIGS. 4 and 5, positioning pin 146 may be positioned adjacent positioning block 140. That is, positioning pin 146 may be substantially aligned with, positioned adjacent and/or may be positioned within proximity of positioning block 140 such that positioning block 140 may contact positioning pin 146, as discussed herein. Additionally as shown in FIGS. 4 and 5, positioning pin 146 may be coupled to slider element 112. Specifically, positioning pin 146 may be coupled to, affixed within, and/or received by one of a plurality of openings 120 formed at least partially through surface 122 of slider element 112. In the non-limiting example shown in FIGS. 4 and 5, positioning pin 146 may be substantially linear and/or may linearly extend from slider element 112, substantially co-planar and/or substantially parallel with linear body section 102B of electrode 100B.

Positioning block 140 of STEM system 110 may position tip section 104B of electrode 100B at a desired orientation relative to component 10 receiving tip section 104B to form a substantially curved hole in component 10. More specifically, positioning block 140 coupled to linear body section 102B of electrode 100B and positioning pin 146 positioned adjacent positioning block 140 may position, direct, adjust, and/or orient tip section 104B of electrode 100B in a desired orientation relative to component 10. The desired orientation of tip section 104B relative to component 10 may be based on the desired characteristics, geometry, and/or shape of the substantially curved hole formed in component 10. That is, tip section 104B may be positioned, adjusted, and/or oriented in the desired orientation prior to beginning operation to ensure electrode 100B forms the substantially curved hole in component 10 in a desired direction, and/or with a desired shape. In a non-limiting example shown in FIG. 5, an end 148 of positioning block 140 may be co-planar with and/or aligned with tip section 104B, and more specifically, end 148 of positioning block 140 may be aligned or co-planar with the direction of the non-linear angle (as) of tip section 104B of electrode 100B. As such, and after positioning block 140 is coupled to linear body section 102B of electrode 100B and end 148 of positioning block 140 is aligned with the direction of the non-linear angle (as) of tip section 104B, the orientation of tip section 104B may be adjusted to the desired orientation by rotating positioning block 140.

In the non-limiting example shown in FIG. 5, positioning pin 146 may further aid positioning block 140 in positioning tip section 104B in the desired orientation. In a non-limiting example, positioning pin 146 may be coupled to and/or positioned within a predetermined opening 120 formed in slider element 112. The predetermined opening 120 of slider element 112 may also correspond to the desired orientation of tip section 104B relative to component 10. Specifically, when positioning pin 146 is coupled to and/or positioned within the predetermined opening 120, positioning block 140 may contact, press against, be held in place, and/or abut positioning pin 146 to maintain tip section 104B of electrode 100B in the desired orientation. In this non-limiting example, positioning pin 146 may aid positioning block 140 by preventing positioning block 140, which contacts and/or abuts positioning pin 146, from undesirably rotating and thus adjusting, orienting, and/or rotating tip section 104B of electrode 100B out of the desired orientation with respect to component 10. Additionally, positioning pin 146 may aid positioning block 140 by providing positioning block 140 a support or brace to contact to maintain positioning block 140/end 148 of positioning block 140 and tip section 104B of electrode 100B in the desired orientation when forming a substantially curved hole within component 10.

FIG. 7 shows a perspective view of component 10 including substantially curved hole 150. Curved hole 150 may be formed in component 10 using, for example, STEM system 110 including electrode 100B (see, FIGS. 4 and 5). As discussed herein, the geometry, shape, size, and/or curvature of curved hole 150 may be dependent upon the characteristics, and more specifically the predetermined length (L) and the predetermined non-linear angle (α_{B}), of tip section 104B of electrode 100B. As shown in FIG. 7, curved hole 150 may be formed between a first opening 152 formed through a top surface 12 of component 10, and second opening 154 formed through a bottom surface 18 of component 10. With reference to reference line (REF), which shows a single planar/linear line formed through the center component 10, substantially curved hole 150 is curved and/or swept within component 10 as curved hole 150 moves between first opening 152 and second opening 154.

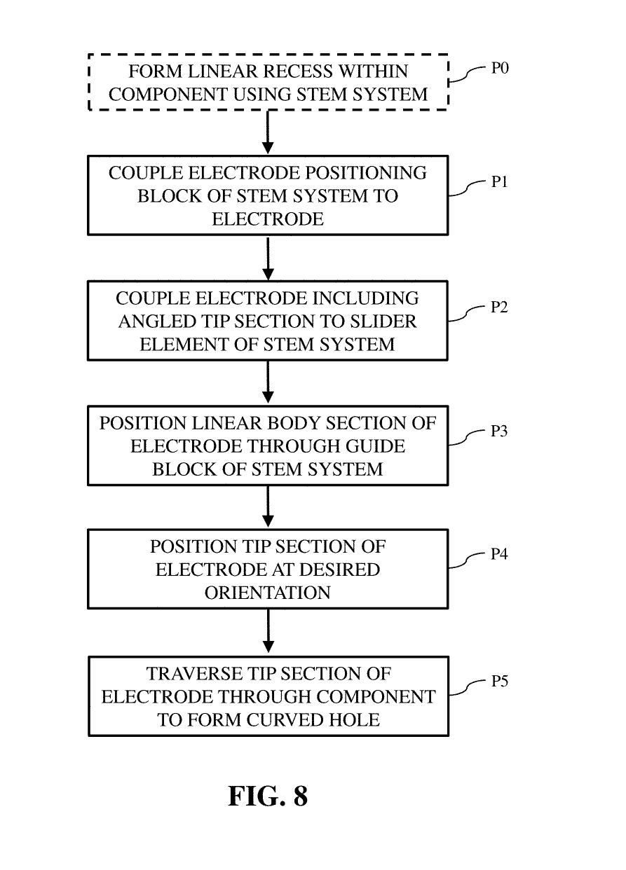

FIG. 8 shows non-limiting example processes for forming a substantially curved hole within a component. Specifically, FIG. 8 is a flowchart depicting example processes for forming a substantially curved hole within a component using a STEM system including an electrode. In some cases, the processes may utilize various STEM systems, as discussed herein with respect to FIGS. 4, 5, 9, 10, and/or 24.

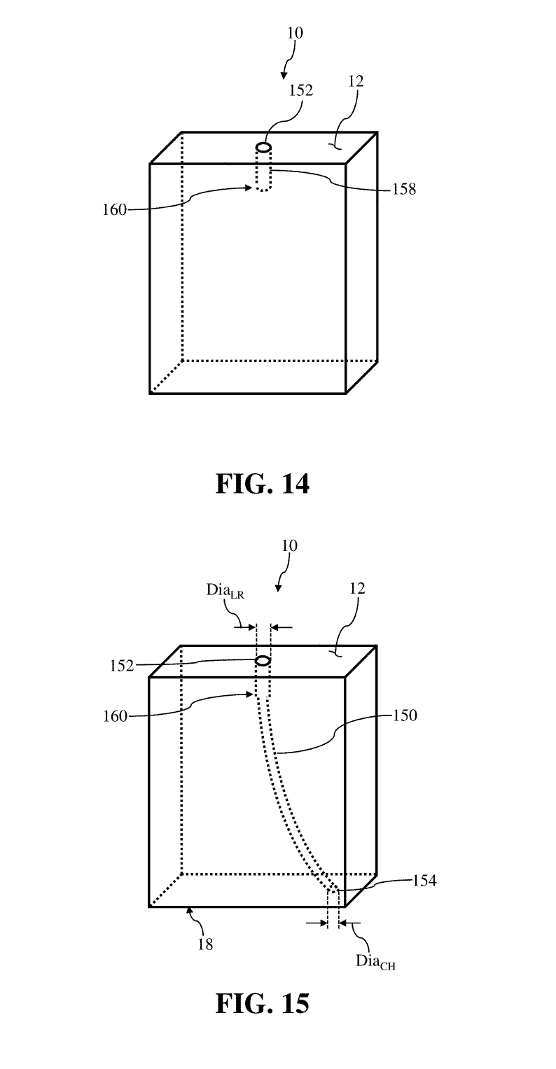

In process P0 (shown in phantom), at least one linear recess may be formed within a component using a STEM system (see, FIGS. 14-23). That is, linear recess(es) may be formed within a component and/or through a surface of the component using a STEM system including an electrode. Forming the linear recess(es) may include, for example, coupling an initial electrode to a slider element of the STEM system and positioning the initial electrode through an aperture of a guide block of the STEM system. The initial electrode utilized to form the linear recess(es) may include a linear body section, and a tip section formed at a distal end of the initial electrode. The tip section of the initial electrode used to form the linear recess(es) may be linearly aligned with and/or co-planar with the linear body section of the initial electrode. Additionally, forming the linear recess(es) within the component may include traversing the linear tip section of initial electrode into and/or partially through the component. In a non-limiting example, the linear recess(es) formed within the component using the initial electrode may include a predetermined diameter. As discussed herein, the predetermined diameter may be large enough to receive an electrode including a non-linear angled tip section used by the STEM system to form the curved hole in the component. Process P0 is shown in phantom as optional and may not be required or performed in order to form a substantially curved hole within the component. In a non-limiting example where process P0 is performed, the initial electrode including the linear tip section used to form the linear recess(es) may be removed from the STEM system, and more specifically the slider element and the aperture of the guide block of the STEM system, before performing additional processes (e.g., processes P1-P4) to form a substantially curved hole within the component.

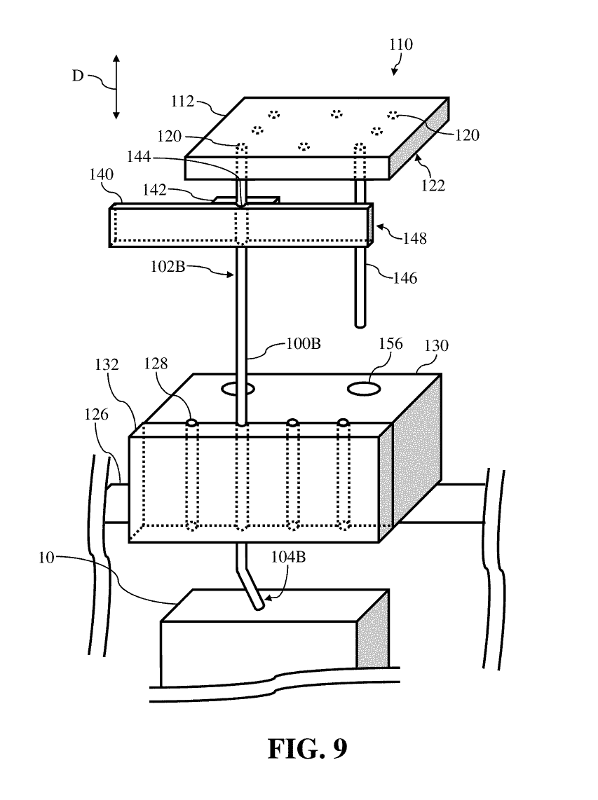

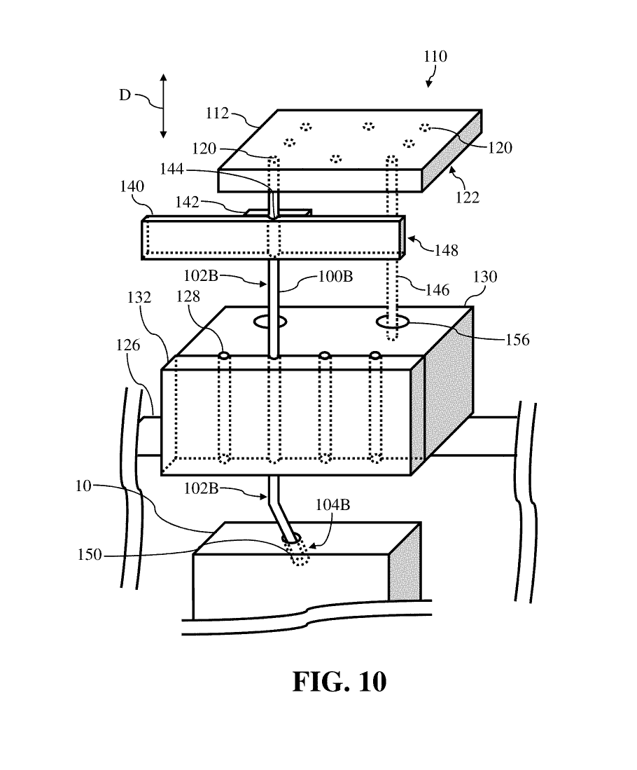

In process P1, a positioning block of the STEM system may be coupled to a distinct or different electrode (see, FIGS. 9 and 10) used within the STEM system. Specifically, the positioning block of the STEM system may be coupled and/or affixed to an electrode, distinct from the initial electrode. The electrode may include a linear body section, and a tip section formed at a distal end of the electrode, adjacent the linear body section. Distinct from the initial electrode, the tip section of the electrode utilized by STEM system in process P1 may be substantially angled. Specifically, the tip section of the electrode may be angled at a non-linear angle relative to the linear body section of the electrode. The tip section of the electrode may include a predetermined length and a predetermined non-linear angle relative to the linear body section of the electrode. The predetermined length and predetermined non-linear angle are based on a desired curvature geometry for the curved hole to be formed in the component. In non-limiting examples, the angled tip section of the electrode may be substantially linear, or may be curved. In a non-limiting example of process P1, the positioning block of the STEM system may be coupled to and/or may slidably engage the linear body section of the electrode. The positioning block may be coupled to and/or affixed to the linear body section of the electrode between a slider element and a guide block of the STEM system. The positioning block may be coupled to and/or affixed to the linear body section of the electrode such that the positioning block does not move, slidably engage and/or traverse the linear body section when forming the substantially curved hole in the component. Coupling the positioning block of the STEM system to the linear body section of the electrode may also include aligning an end of the positioning block with the tip section of the electrode. Specifically, the end of the positioning block may be aligned and/or co-planar with the direction of the non-linear angle of the tip section of the electrode.

In process P2 the electrode, distinct from the initial electrode, may be coupled to and/or affixed to the slider element of the STEM system. Specifically, a distinct distal end of the electrode, opposite the tip section, may be coupled and/or affixed to the slider element of the STEM system. The distal end of the electrode coupled to the slider element may also include a portion of the linear section of the electrode. In a non-limiting example, the electrode may be coupled, affixed, and/or positioned within one of a plurality of openings formed in the slider element of the STEM system. The slider element of the STEM system may be positioned adjacent the positioning block coupled to the electrode, and opposite the tip section of the electrode. In process P3, the electrode may be positioned through a guide block of the STEM system (see, FIGS. 9 and 10). Specifically, the linear body section of the electrode may be positioned through an aperture formed in the guide block positioned adjacent the component and/or coupled to a component fixture of the STEM system. In a non-limiting example, the guide block may include a plurality of sections, and the aperture may be formed between the sections. That is, guide block may include a first section and a second section coupled to the first section. A portion of the aperture may be formed in each of the first section and the second section such that when the first section and second section are coupled, a complete, linear aperture may be formed through the guide block. Positioning the linear body section of the electrode through the aperture of the guide block may include aligning the linear body section with a portion of the aperture and/or positioning the linear body section between the first section and second section of the guide block, and subsequently coupling the first section and the second section. The aperture of the guide block may substantially receive and/or slidably engage the linear body section of the electrode.

In process P4, the tip section of the electrode of STEM system may be positioned at a desired orientation relative to the component using the positioning block (see, FIGS. 9 and 10). That is, the tip section of the electrode may be positioned at a desired orientation relative to the component by adjusting, rotating and/or orienting the positioning block until the end of the positioning block aligned with the direction of the non-linear angle of the tip section is positioned and/or oriented in the desired orientation. To aid in positioning the tip section of the electrode at the desired orientation, STEM system may utilize a positioning pin to contact the positioning block. In a non-limiting example, positioning the tip section of the electrode at the desired orientation may include coupling an electrode positioning pin to a predetermined opening formed in the slider element of the STEM system, and positioning the positioning block adjacent to and/or to statically contact the positioning pin. The predetermined opening of the slider element may correspond to the desired orientation of the tip 104B relative to the component. Specifically, when the positioning pin is coupled to and/or positioned within the predetermined opening, the positioning block may contact, press against, be held in place, and/or abut the positioning pin to maintain the end of the positioning block and the tip section of electrode in the desired orientation relative to the component.

In another non-limiting example, positioning the tip section of the electrode at the desired orientation may include coupling a positioning pin to a predetermined opening formed in the guide block of the STEM system, and positioning the positioning block adjacent to and/or to contact and slidably engage the positioning pin coupled to the guide block (see, FIGS. 9 and 10). In this non-limiting example, the predetermined opening formed in the guide block may be structured and function in a substantially similar manner as the predetermined opening formed in the slider element. As such, when the positioning pin is coupled to and/or positioned within the predetermined opening formed in the guide block, the positioning block may contact, press against, and/or abut the positioning pin to maintain the end of the positioning block and the tip section of electrode in the desired orientation relative to the component.

In process P5, the tip section of the electrode may be traversed through the component (see, FIG. 10). Specifically, the tip section, angled at a non-linear angle relative to the linear body section, may be traversed through the component to form the substantially curved hole within the component during operation of the electrode of the STEM system. As the operational electrode, and more specifically the tip section, is traversed through the component, the electrode may remove material from the component to form the curved hole therein. As discussed herein, the predetermined length and the predetermined non-linear angle of the tip section of the electrode may guide, dictate, and/or determine the curvature geometry of the curved hole formed in the component using the STEM system. Traversing the tip section of the electrode through the component may include additional processes. Some of these processes may be performed regardless of whether optional process P0 is performed, while some of the additional processes may only be performed after process P0 is performed. The additional processes of traversing the tip section of the electrode through the component regardless of whether optional process P0 is performed are discussed first.

In one non-limiting example, the positioning pin may be removed from the STEM system prior to traversing the tip section of the electrode through the component. That is, subsequent to positioning the electrode positioning block to contact the electrode positioning pin, and prior to traversing the tip section of the electrode through the component to form the curved hole within the component during operation of the electrode of the STEM system, the positioning pin may be removed from the slider element or the guide block of the STEM system. As a result, the positioning block may be positioned in a desired position, but may not touch and/or contact the positioning pin as the tip section traverses through the component.

In an additional non-limiting example where the positioning pin is affixed to the predetermined opening in the slider element, traversing the tip section of the electrode through the component may also include positioning the positioning block to statically contact the positioning pin, and moving the slider element, the electrode, the positioning block, and the positioning pin in a direction toward the guide block and/or the component (see, FIGS. 9 and 10). In this non-limiting example, positioning block and positioning pin may move in tandem, and may move toward the guide block with the slider element as a result of the positioning block being affixed to the linear body section of the electrode, and the positioning pin being coupled to the slider element, adjacent the positioning block. Additionally, in this non-limiting example, traversing the tip section of the electrode through the component may also include positioning at least a portion of the positioning pin coupled to the slider element within a recess formed in the guide block of the STEM system (see, FIG. 10). That is, the guide block of the STEM system may include at least one recess that may receive a portion of the positioning pin as the slider element moves closer to the guide block and/or the electrode moves through the component to form the curved hole within the component.

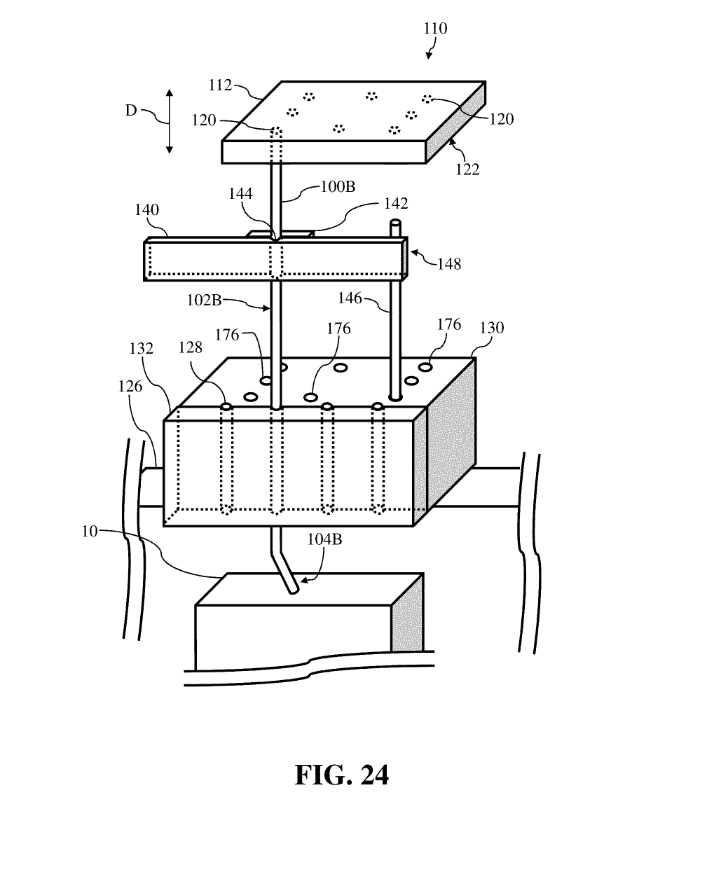

In another non-limiting example where the positioning pin is affixed to the predetermined opening in the guide block (see, FIG. 24), traversing the tip section of the electrode through the component may also include positioning the positioning block to slidably engage the positioning pin, and moving the slider element, the electrode, and the positioning block in a direction toward the guide block, positioning pin, and/or the component. In this non-limiting example, positioning block may move toward the guide block with the slider element and may slidably engaging positioning pin coupled to and/or affixed to the guide block.

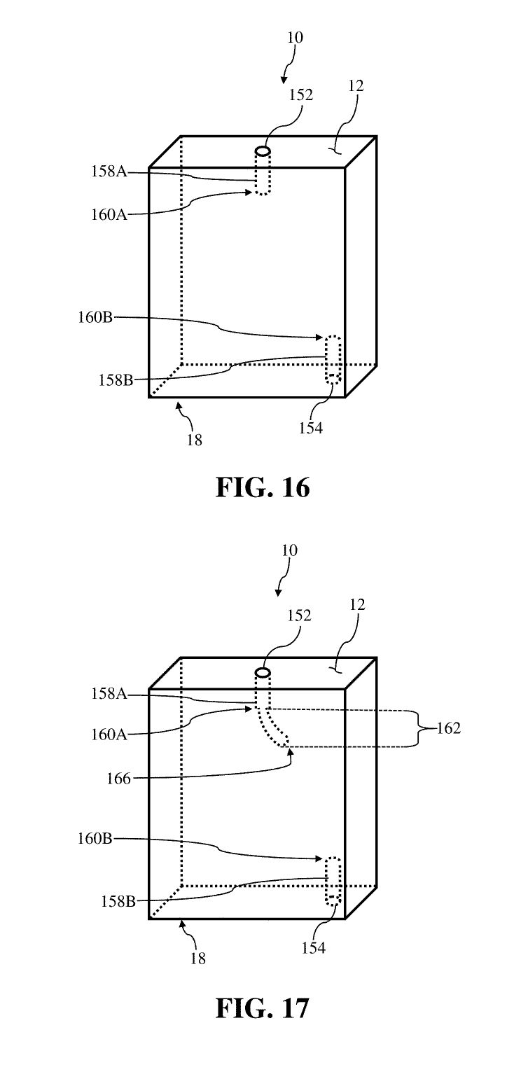

Regardless of perform process P0, traversing the tip section of the electrode through the component in process P5 may also include stopping operation of the tip section of the electrode partially through the component to form a first portion of the curved hole, removing the tip section of the electrode from the first portion of the curved hole, and replacing the electrode of the STEM system with a unique electrode including a linear section and a non-linear or angled tip section. Replacing the electrode with the unique electrode may be accomplished by performing the similar processes P1-P3 discussed herein. The angled tip section of the unique electrode may be positioned in a distinct, desired orientation relative to the component using the positioning block. Positioning the tip section of the unique electrode to a distinct, desired orientation may include similar processes as discussed herein with respect to process P4 including, but not limited to, coupling the positioning pin to a distinct, predetermined opening formed in the slider element/guide block, and positioning, adjusting, and/or rotating the positioning block to contact, press against, and/or abut the positioning pin to position and/or maintain the end of the positioning block and the tip section of unique electrode in the distinct, desired orientation relative to the component. Once the tip section of the unique electrode is positioned to the distinct, desired orientation, the tip section of the unique electrode may be positioned directly adjacent an end point of the first portion of the curved hole formed within the component, and subsequently, the tip section of the unique electrode positioned at the distinct, desired orientation may be traversed through the component to form a second portion of the curved hole during operation of the unique electrode of the STEM system. The second portion of the curved hole may be formed adjacent to and/or may be in communication with the first portion of the curved hole. Additionally, the second portion of the curved hole may have a distinct curve direction than the first portion of the curved hole. As a result, the curved hole may include two distinct curvature directions (see, FIGS. 16-18 and 20).

In non-limiting examples where process P0 is performed, traversing the tip section of the electrode through the component in process P5 may also include inserting the tip section, including the non-linear angle, of the electrode into the linear recess formed within the component, and positioning the tip section of the electrode directly adjacent an end point of the linear recess. The linear recess may include the predetermined diameter which may be large enough to receive the non-linear angled tip section of the electrode. That is, the linear recess may be shaped and/or include the predetermined diameter that may allow from the angled tip section of the electrode to be positioned within the linear recess without contacting the sidewalls of the recess, and potentially displacing or deforming the predetermined non-linear angle of the tip section, which in turn may affect the geometry of the substantially curved hole formed in the component. In this non-limiting example, process P5 may also include traversing the tip section of the electrode through the component to form the curved hole in the component during operation of the electrode of the STEM system. The curved hole formed by the tip section traversing through the component may be formed adjacent to and in communication with the linear recess (see, FIGS. 14-15).

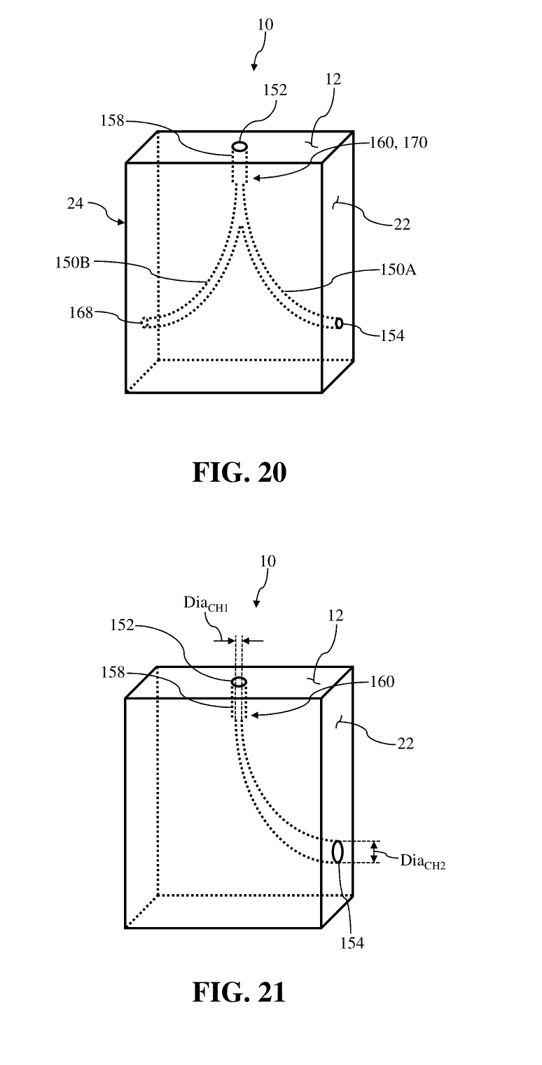

In additional non-limiting examples where process P0 is performed, traversing the tip section of the electrode through the component in process P5 may also include positioning the tip section of the electrode directly adjacent the end point of the linear recess and a beginning point of a first curved hole formed within the component. The first curved hole may be formed adjacent to and in communication with the linear recess as discussed herein. This example may also include adjusting the position of the tip section of the electrode to a distinct, desired orientation relative to the component using the positioning block. The distinct, desired orientation may be distinct or different from the desired orientation used to form the first curved hole within the component. Additionally in the non-limiting example, traversing the tip section in process P5 may include traversing the tip section of the electrode, positioned at the distinct, desired orientation, through the component to form a distinct or second curved hole adjacent to and in communication with the first curved hole and the linear recess, respectively, during operation of the electrode of the STEM system. The second or distinct curved hole may include a distinct curve direction than the curvature direction of the first curved hole (see, FIG. 20).

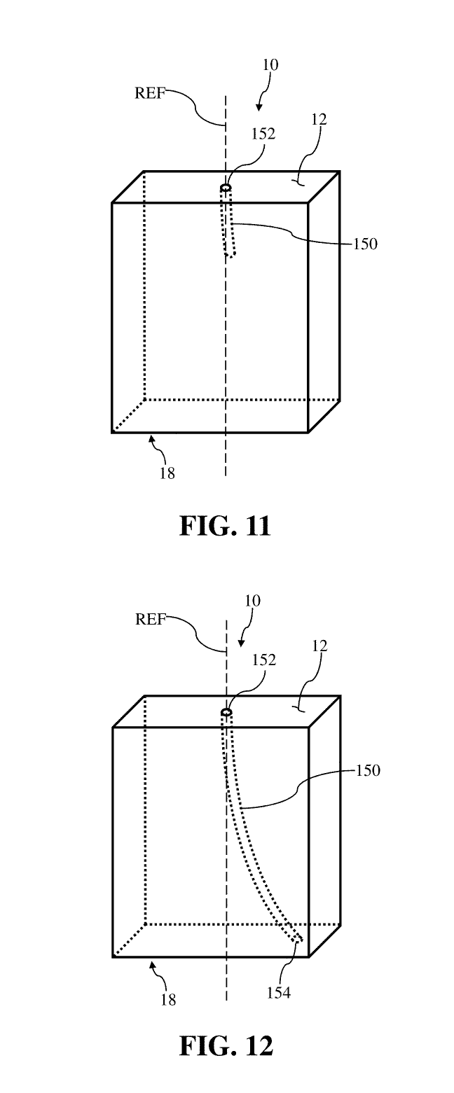

Turning to FIGS. 9-12, various views of STEM system 110 and component 10 undergoing processes for forming curved hole 150 in component 10. Specifically, FIGS. 9 and 10 show perspective views of STEM system 110 performing a process of forming curved hole 150 in component 10, and FIGS. 11 and 12 show perspective views of component 10 undergoing processes for forming curved hole 150 therein using STEM system 110. It is understood that similarly numbered and/or named components may function in a substantially similar fashion. Redundant explanation of these components has been omitted for clarity.

FIG. 9 shows STEM system 110 configured to form curved hole 150 within component 10 (see, FIG. 12). Specifically, STEM system 110 shown in FIG. 9 may form curved hole 150 within component 10 by performing processes P1-P4 discussed herein with respect to FIG. 8. In the non-limiting shown in FIG. 9, electrode 100B, including linear body section 102B and tip section 104B, may be coupled to slider element 112 of STEM system 110. Additionally, and as shown in FIG. 9, linear body section 102B of electrode 100B may be positioned through aperture 128 of guide block 124, and positioning block 140 may be coupled to linear body section 102B of electrode 100B between slider element 112 and guide block 124. Furthermore, tip section 104B, including non-linear angle (as), of electrode 100B may be positioned at a desired orientation relative to component 10 using positioning block 140 and positioning pin 146. Coupling electrode 100B to slider element 112, positioning linear body section 102B through aperture 128 of guide block 124, coupling positioning block 140 to linear body section 102B, and positioning tip section 104B at the desired orientation using positioning block 140, as shown in FIG. 9, may correspond to processes P1-P4 of FIG. 8.

In FIG. 10, STEM system 110 is shown after performing additional processes for forming curved hole 150 within component 10. That is, FIG. 10 shows STEM system 110 after partially performing process P5 discussed herein with respect to FIG. 8. For example, FIG. 10 shows STEM system 110 and component 10 part-way through performing the process P5 of traversing tip section 104B of electrode 100B through component 10 to form curved hole 150 within component 10 during operation of electrode 100B. Specifically, slider element 112, and electrode 100B coupled to slider element 112, may be moved toward component 10 to traverse electrode 100B, and specifically tip section 104B of electrode 100B, through component 10 to form curved hole 150. Traversing tip section 104B of electrode 100B through component 10 to form curved hole 150, as shown in FIG. 10, may correspond to process P5 of FIG. 8.

Additionally as shown in FIG. 10, tip section 104B of electrode 100B may be traversed through component 10 to form curved hole 150 by moving slider element 112 and electrode 100B in a direction (D) toward component 10. Specifically, and with comparison to FIG. 9, tip section 104B may be traversed through component 10 by moving slider element 112, electrode 100B coupled and/or affixed to slider element 112, and positioning block 140 coupled to linear section 102B of electrode 100B, in a direction (D) toward component 10. In a non-limiting example, a portion of linear body section 102B positioned between guide block 124 and component 10 may appear to be angled, deformed, and/or flexed when traversing tip section 100B through component 10 to form curved hole 150. As discussed herein with respect to FIGS. 1-3, linear body section 102B of electrode 100B may be formed from a substantially elastic material. As such, linear body section 102B may be slightly bent, angled, deformed, and/or flexed as electrode 100B traverses through component 10 when forming curved hole 150 therein.

Positioning pin 146 is shown in phantom in FIG. 10 as being optional and/or indicating that positioning pin 146 may not be coupled to slider element 112 before traversing tip section 104B of electrode 100B through component 10. That is, positioning pin 146 may be removed from slider element 112 subsequent to positioning block 140 to contact positioning pin 146, and prior to traversing tip section 104B of electrode 100B through component 10 to form curved hole 150.

In another non-limiting example, positioning pin 140 may remain coupled and/or affixed to slider element 112 of STEM system 110. As a result, positioning pin 146 may move in a direction (D) toward component 10, and toward guide block 124, respectively. In the non-limiting example shown in FIG. 10 as slider element 112, electrode 100B, positioning block 140, and positioning pin 146 are moved toward and/or positioned substantially adjacent guide block 124, a portion of positioning pin 146 may be positioned within and/or received by a recess 156 formed within guide block 124. More specifically, first section 130 of guide block 124 may include at least one recess 156 that may receive at least a portion of positioning pin 146 when traversing tip section 104B through component 10. Recess(es) 156 of guide block 124 may receive at least a portion of positioning pin 146 when traversing tip section 104B through component 10 in order to allow slider element 112 to move electrode 100B through component 10 to form curved hole 150 without obstruction and/or undesirably contact between guide block 124 and positioning pin 146.

Turning to FIGS. 11 and 12, component 10 is shown undergoing process P5 as discussed herein with respect to FIG. 8. Specifically, FIG. 11 shows an initial stage and/or a partial curved hole 150 formed in component 10, and FIG. 12 shows a completed or final curved hole 150 formed through component 10. As discussed herein, and specifically shown in FIG. 10, curved hole 150 may be formed through component 10 by traversing tip section 104B of electrode 100B through component 10 during operation of electrode 100B. Electrode 100B may be omitted from FIGS. 11 and 12 for clarity. In the non-limiting example shown in FIGS. 11 and 12, tip section 104B of electrode 100B may initially enter and/or pass through top surface 12 of component 10 and may traverse through component 10 until tip section 104B exits component 10 through bottom surface 18. As a result, curved hole 150 may be formed between first opening 152 formed through top surface 12 of component 10, and second opening 154 formed through bottom surface 18 of component 10.

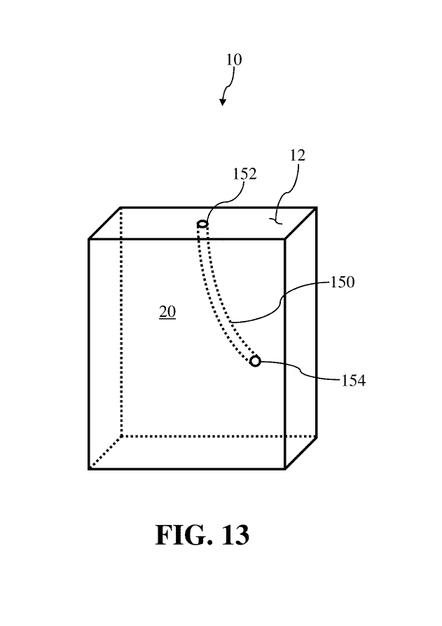

FIGS. 13-23 show perspective views of a variety of non-limiting examples of curved hole(s) 150 being formed through component 10. It is understood that curved hole(s) 150 formed in components 10 depicted in FIGS. 13-23 may be formed using STEM system 110 depicted and discussed herein with respect to FIGS. 4, 5, 9, and 10, and/or by performing similar processes P0-P5 discussed herein with respect to FIG. 8. Additionally, it is understood that similarly numbered and/or named components may function in a substantially similar fashion. Redundant explanation of these components has been omitted for clarity.

Turning to FIG. 13, component 10 includes curved hole 150 formed therein. With comparison to component shown in FIG. 12, curved hole 150 shown in the non-limiting example of FIG. 13 may include a distinct geometry and/or direction of curvature. Specifically, and as shown in FIG. 13, curved hole 150 may be formed between first opening 152 formed through top surface 12 of component 10, and second opening 154 formed through a front surface 20 of component 10. As discussed herein, the geometry of curved hole 150 and/or the direction of curvature for curved hole 150 may be dictated and/or determined by the predetermined length (L) of tip section of electrode (e.g., tip section 104B of electrode 100B; FIGS. 2 and 4), the predetermined non-linear angle (as) of the electrode, and/or positioning the tip section of the electrode in the desired orientation relative to component 10 using positioning block 140 (see, FIG. 4).

FIGS. 14 and 15 show another non-limiting example of component 10 undergoing processes P0-P5 as discussed herein with respect to FIG. 8. Specifically, FIG. 14 shows a linear recess 158 formed within component 10, and FIG. 15 shows a curved hole 150 formed within component 10, and adjacent linear recess 158. As discussed herein with respect to process P0 in FIG. 8, linear recess 158 may be formed within component 10 using an electrode including a substantially linear tip section (e.g., electrode 100A; FIG. 1). In the non-limiting example shown in FIG. 14, the electrode forming linear recess 158 may traverse partially through top surface 12 of component 10 and partially into component 10 to form an end point 160 of linear recess 158 within component 10. Next, and as discussed in detail with respect to the processes shown in FIG. 8, the electrode forming linear recess 158 may be removed from STEM system 110 (see, FIGS. 4, 5, 9, and 10), an electrode including an angled tip section (e.g., electrode 100B) may be included within STEM system 110, as discussed herein with respect to processes P1-P4. Once included within STEM system 110, and as discussed herein with respect to process P5 in FIG. 8, the electrode including the angled tip section may be: inserted into linear recess 158 formed in component 10, positioned directly adjacent end point 160 of linear recess 158, and traversed through component 10 to form curved hole 150 that may be adjacent to, stem from, and/or in communication with linear recess 158 formed in component 10. In the non-limiting example shown in FIG. 15 curved hole 150 may be formed and/or extend from end point 160 of linear recess 158 to second opening 154 formed through bottom surface 18 of component 10.

Also shown in FIG. 15, and as discussed herein, linear recess 158 may include a predetermined diameter (Dia_{LR}) that is distinct from the predetermined diameter (Dia_{CH}) of curved hole 150. Specifically, the diameter (Dia_{LR}) of linear recess 158 may be larger than the diameter (Dia_{CH}) of curved hole 150. Linear recess 158 may be shaped and/or include the larger diameter (Dia_{LR}) to allow the angled tip section of the electrode (e.g., tip section 104B of electrode 100B; FIG. 2) to be positioned within linear recess 158 without contacting the sidewalls of linear recess 158, and potentially displacing or deforming the predetermined non-linear angle (α) of the tip section of the electrode. That is, the diameter (Dia_{LR}) of linear recess 158 may be sized (e.g., larger than the diameter (Dia_{CH}) of curved hole 150) to receive angled tip section of the electrode and/or compensate for the angular offset of angled tip section such that the tip section of the electrode can be positioned within linear recess 158 without contacting the sidewalls of linear recess 158.

FIGS. 16-18 show another non-limiting example of component 10 undergoing processes P0-P5 as discussed herein with respect to FIG. 8. As shown in FIG. 16, two distinct linear recesses 158A, 158B may be formed within component 10. Specifically, a first linear recess 158A may be formed through top surface 12 of component 10 and a second linear recess 158B may be formed through bottom surface 18 of component 10. FIG. 17 shows a partial or first portion 162 of curved hole 150 formed within component 10. First portion 162 of curved hole 150 may be formed adjacent to, stem from, and/or may be in communication with first linear recess 158A formed in component 10. Additionally as shown in FIG. 17, first portion 162 of curved hole 150 may include a first direction of curvature for curved hole 150 formed within component 10. As discussed herein, first portion 162 of curved hole 150 may include the first direction of curvature as a result of positioning the angled tip section of the electrode (e.g., tip section 104B of electrode 100B; FIG. 2) in the desired orientation relative to component 10 using positioning block 140 (see, FIG. 4).

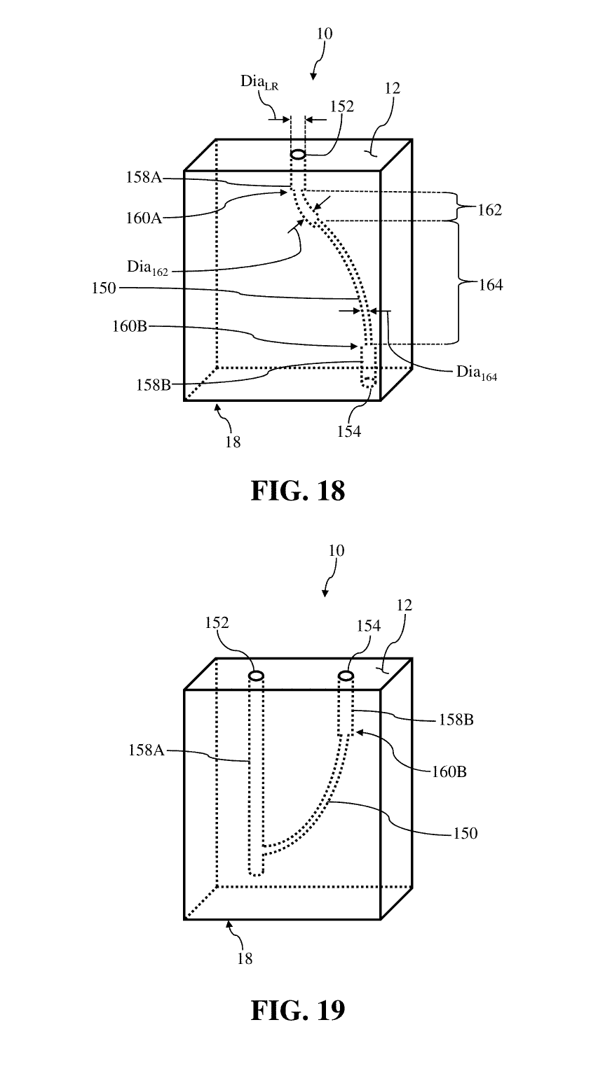

Turning to FIG. 18, and with continued reference to FIG. 17, component 10 is shown including completed curved hole 150. Specifically, component 10 shown in FIG. 18 shows curved hole 150 connecting and/or coupling first linear recess 158A and second linear recess 158B. Completed curved hole 150 shown in FIG. 18 may include second portion 164 formed adjacent to and/or in communication with first portion 162 of curved hole 150 and second linear recess 158B, respectively. Second portion 164 of curved hole 150 may include a second direction of curvature for curved hole 150 formed within component 10. In the non-limiting example, the second direction of curvature for second portion 164 of curved hole 150 may be distinct and/or different from the first direction of curvature for first portion 162 of curved hole 150. As a result, curved hole 150 formed within component 10 may include a substantially “S” or serpentine shape. Curved hole 150 including first portion 162 and second portion 164 may be formed by performing processes discussed herein with respect to FIG. 8. For example, after forming first portion 162 with the electrode including the angled tip section (e.g., electrode 100B; FIG. 2) by positioning the angled tip section in a desired orientation relative to component 10, the electrode may be replaced by a unique electrode including an angled tip section, and the angled tip section of the unique electrode may be positioned in a distinct, desired orientation relative to component 10. The distinct, desired orientation may be different or unique from the desired orientation used to form first portion 162 of curved hole 150. Next, the angled tip section of the unique electrode positioned in the distinct, desired orientation, may be positioned adjacent an end point 166 (see, FIG. 17) of first portion 162, and then may be traversed through component 10 to form second portion 164 of curved hole 150.

Also shown in FIG. 18, curved hole 150 formed from first portion 162 and second portion 164 may include distinct and/or unique diameters. That is, and as discussed herein, first portion 162 of curved hole 150 may include a distinct, and more specifically a smaller, diameter (Dia₁₆₂) than the diameter (Dia_{LR}) of linear recess 158A. Additionally, and as shown in FIG. 18, second portion 164 of curved hole 150 may include a distinct, and more specifically a smaller, diameter (Dia₁₆₄) than the diameter (Dia₁₆₂) of first portion 162 of curved hole 150. The diameter (Dia₁₆₄) of second portion 164 may be smaller than the diameter (Dia₁₆₂) of first portion 162 of curved hole 150 for similar reasons and/or rationale as the diameter of curved hole 150 being smaller than the diameter (Dia_{LR}) of linear recess 158 as discussed herein with respect to FIG. 15.

In another non-limiting example, a section of first portion 162 of curved hole 150 may be enlarged. Specifically, an end section and/or a second of first portion 162 of curved hole 150 formed directly adjacent second portion 164 of curved hole 150 (e.g., end point 166; FIG. 17) may be formed to be enlarged and/or may include a diameter that is larger than the diameter (Dia₁₆₂) of remaining section of first portion 162 of curved hole 150. The section of first portion 162 of curved hole 150 may be formed to be enlarged in order to receive, compensate, and/or accommodate an electrode including a non-linear tip section (e.g., electrode 100B, tip section 104B) forming second portion 164 of curved hole 150. That is, and in the non-limiting example, the tip section of the electrode may be rotated within the enlarged section of first portion 162 to orient the tip section in a distinct, desired orientation relative to component 10 to form second portion 164. As such, the enlarged section of first portion 162 of curved hole 150 may be sized to receive angled tip section of the electrode, allow the tip section to rotate within the enlarged section of first portion 162, and/or compensate for the angular offset of angled tip section such that the tip section of the electrode can be positioned within the enlarged section of first portion 162 without contacting the sidewalls of first portion 162.

FIG. 19 shows a perspective view of component 10 including first linear recess 158A, second linear recess 158B, and curved hole 150. Specifically, first linear recess 158A may extend from first opening 152 formed through top surface 12 of component 10, and second linear recess 158B may extend from second opening 154 formed through top surface 12, adjacent first linear recess 158A. Additionally in the non-limiting example shown in FIG. 19, curved hole 150 may be formed adjacent to and/or in communication with second linear recess 158B. Additionally, curved hole 150 may be formed within component 10 to be in communication with first linear recess 158A. Specifically, curved hole 150 may be formed within component 10 such that the direction of curvature for curved hole 150 is toward first linear recess 158A, and curved hole 150 may be formed through, in communication with, and/or may intersect first linear recess 158A within component 10.

FIG. 20 shows another non-limiting example of component 10 including various curved holes 150A, 150B. Specifically, component 10 shown in FIG. 20 includes linear recess 158 formed through top surface 12 of component 10, two distinct curved holes 150A, 150B formed adjacent to and in communication with linear recess 158 and each other, respectively. First curved hole 150A may be formed adjacent to and in communication with linear recess 158A and second curved hole 150B, respectively, and may extend to second opening 154 formed a first side surface 22 of component 10. Additionally, first curved hole 150A may be formed adjacent to and in communication with linear recess 158A and first curved hole 150A, respectively, and may extend to a third opening 168 formed in a second side surface 24 of component 10.

Two distinct curved holes 150A, 150B may be formed in component 10 by performing processes discussed herein with respect to FIG. 8. For example, linear recess 158 may be formed in component 10, and then first curved hole 150A may be formed in component 10 using the electrode including the angled tip section (e.g., electrode 100B; FIG. 2) positioned in a desired orientation relative to component 10, as similarly discussed herein. Once first curved hole 150A is formed, the angled tip section of the electrode may be adjusted to a distinct, desired orientation relative to component 10. The distinct, desired orientation may be different or unique from the desired orientation used to form first curved hole 150A in component 10. Next, the angled tip section of the electrode, now positioned in the distinct, desired orientation, may be positioned adjacent an end point 160 of linear recess 158 and/or a beginning point 170 of first curved hole 150A, and then may be traversed through component 10 to form second curved hole 150B.

FIG. 21 shows another non-limiting example of component 10 including curved hole 150 formed therein. Specifically, FIG. 21 shows curved hole 150 formed between first opening 152 formed through top surface 12 of component 10, and second opening 154 formed through side surface 22 of component 10. Additionally in the non-limiting example shown in FIG. 21, curved hole 150 may include a varying and/or non-uniform diameter (Dia_{CH}). That is, and distinct from curved hole 150 discussed and shown herein with respect to FIG. 7, curved hole 150 shown in FIG. 21 may include a non-uniform diameter (Dia_{CH}). Specifically, the diameter (Dia_{CH}) of curved hole 150 may increase as over the length of curved hole 150, and/or as curved hole moves from linear recess 158 to second opening 154. In the non-limiting example, the first diameter (Dia_{CH1}) of a portion of curved hole 150 positioned directly adjacent linear recess 158 may be smaller than the second diameter (Dia_{CH2}) of a portion of curved hole 150 positioned directly adjacent second opening 154.

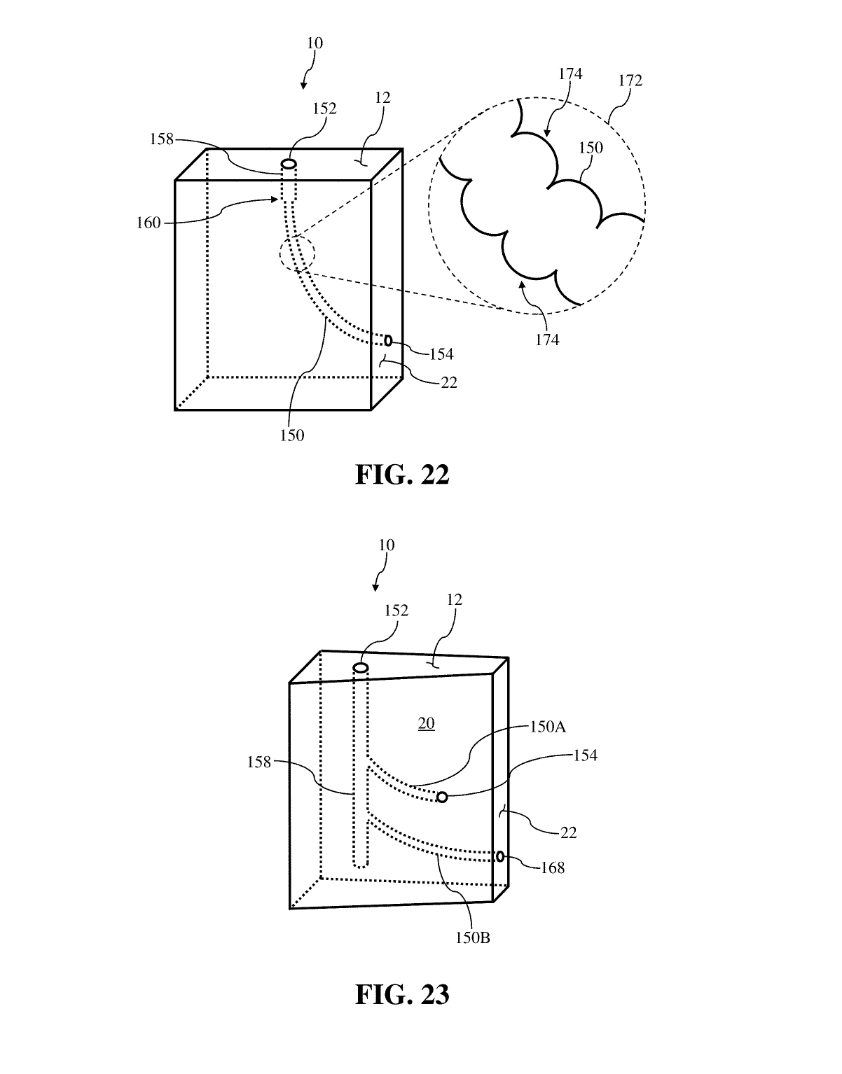

FIG. 22 shows another non-limiting example of component 10 including curved hole 150 formed therein. Similar to curved hole 150 shown in FIG. 21, FIG. 22 shows curved hole 150 formed between first opening 152 formed through top surface 12 of component 10, and second opening 154 formed through side surface 22 of component 10. Additionally, FIG. 22 shows an insert 172 including a magnified portion of curved hole 150. As shown in insert 172, curved hole 150 formed within component 10 may include turbulations 174. Turbulations 174 may be formed in curved hole 150 by, for example, varying the strength of the emit electrical discharge of the electrode (e.g., electrode 100B) used by STEM system 110 to form curved hole 150 within component 10. Turbulations 172 may be formed within curved hole 150 to induce turbulated airflow and/or increase heat transfer of fluid passing through curved hole 150.

FIG. 23 shows a perspective view of component 10 including linear recess 158, and a plurality of curved holes 150A, 150B. In the non-limiting example shown in FIG. 23, each of the plurality of distinct curved holes 150A, 150B may be formed adjacent, in communication with, and/or may intersect with linear recess 158. Specifically, first curved hole 150A may be formed adjacent to and/or in communication with linear recess 158 and may extend to second opening 154 formed in front surface 20 of component 10. Additionally, second curved hole 150B may be formed adjacent to and/or in communication with linear recess 158, below first curved hole 150A, and may extend to third opening 168 formed in side surface 22 of component 10.

It is understood that the plurality of components 10 shown in FIGS. 11-23 are depictions of non-limiting examples, and therefore are not the exclusive configurations for component 10 and/or curved hole(s) 150 formed therein. Additionally, it is understood that number of curved holes 150 and the configuration/characteristics (e.g., orientation, degree of curvature, co-planer orientation of various holes, and the like) of curved hole(s) 150 depicted in FIGS. 11-23 are illustrative. As such, it is understood that component 10 may include curved hole(s) 150 having any combination of configurations/characteristics as those shown in FIGS. 11-23, or any other configurations and/or characteristics that may be achieved when forming curved hole(s) 150 using STEM system 110 (see, FIGS. 4-6), as discussed herein.

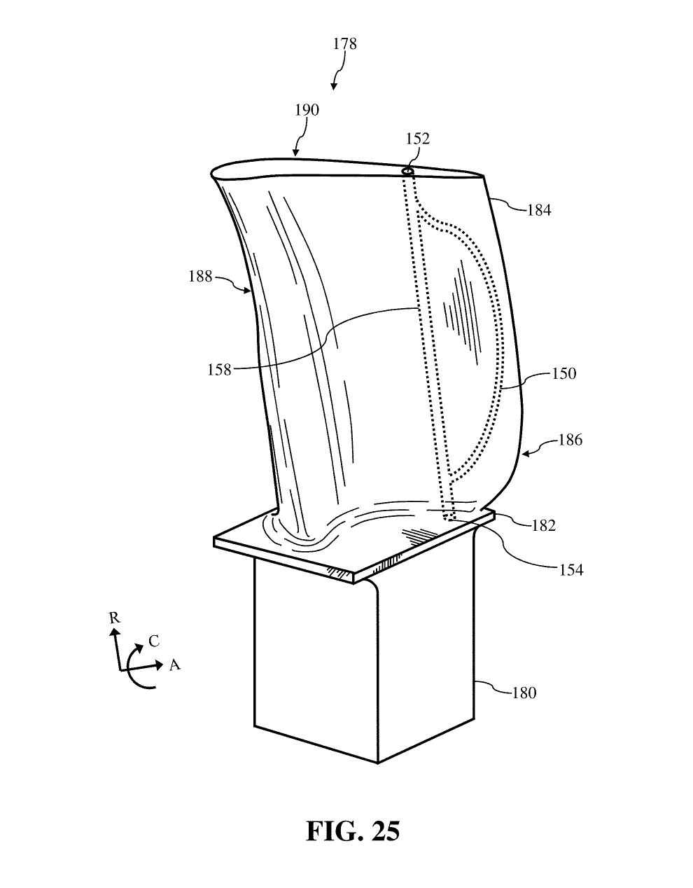

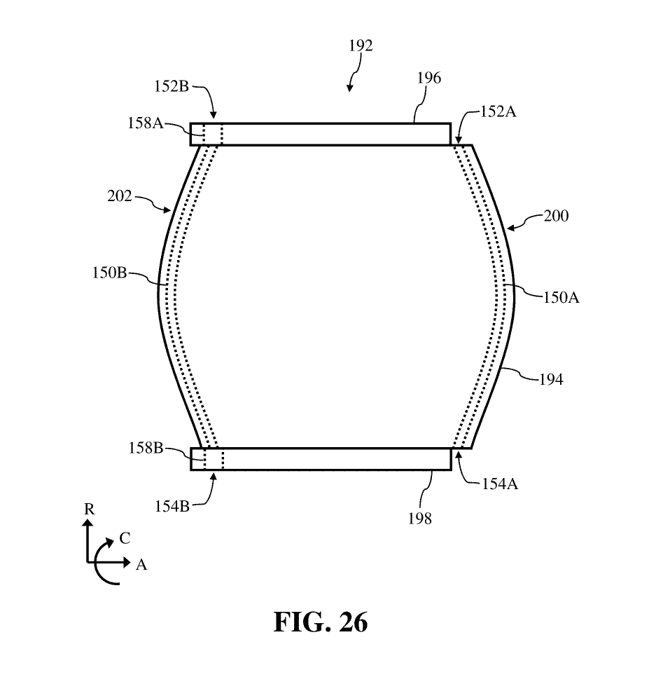

Furthermore, it is understood that component 10 may be a non-limiting representation of any component that may include curved hole(s) 150 formed therein, and/or a component that may utilize curved hole(s) 150 formed at least partially through the body of component 10. For example, and as discussed (see, FIGS. 25 and 26) component 10 may represent a portion or component (e.g., airfoil) of a turbine blade or a stator vane of a turbine system. As such, the various surfaces of component 10 (e.g., top surface 12, front surface 20, side surface 22, and so on) may correspond to the various surfaces, sections, and/or edges (e.g., tip section, pressure side, trailing edge, and so on) of the turbine blade and/or stator vane of the turbine system.

FIG. 24 shows a perspective view of another non-limiting example of STEM system 110 including electrode 100B. It is understood that similarly numbered and/or named components may function in a substantially similar fashion. Redundant explanation of these components has been omitted for clarity.

In the non-limiting example shown in FIG. 24, STEM system 110 may include positioning pin 146 positioned, coupled, and/or affixed to guide block 124. Specifically, and as shown in FIG. 24, first section 130 of guide block 124 may include a plurality of openings 176 that may receive positioning pin 146 to coupled and/or affix positioning pin 146 to guide block 124 of STEM system 110. Similar to openings 120 formed in slider element 112 as shown in discussed herein with respect to FIGS. 4 and 5, openings 176 formed in first section 130 of guide block 124 may receive positioning pin 146 to aid positioning block 140 in positioning and/or orienting tip section 104B of electrode 100B in a desired orientation with respect to component 10. Similar to the non-limiting example discussed herein, once positioning pin 146 aids positioning block 140 in positioning and/or orienting tip section 104B of electrode 100B in a desired orientation with respect to component 10, positioning pin 146 may be removed from guide block 124 prior to traversing tip section 104B of electrode 100B through component 10 to form curved hole 150.

In another non-limiting example, and distinct form the non-limiting examples of STEM system 110 discussed herein with respect to FIGS. 4, 5, 9 and 10, positioning pin 146 may remain stationary and/or in a fixed position as slider element 112 moves in a direction (D) to traverse tip section 104B of electrode 100B through component 10 to form curved hole 150. That is, because positioning pin 146 is coupled and/or affixed to guide block 124, which is affixed to component fixture 126 and stationary when performing the processes (e.g., process P0-P5) for forming curved hole 150 within component 10, positioning pin 146 may also remain stationary as slider element 112, electrode 100B, and positioning block 140 move in a direction (D) toward component 10. As a result, as discussed herein with respect to process P5 in FIG. 8, positioning block 140 may contact and slidably engage positioning pin 146 when slider element 112 moves in direction (D) to traverse tip section 104B of electrode 100B through component 10 to form curved hole 150. Additionally as shown in FIG. 24, the plurality of openings 120 formed in slider element 112 may be substantially aligned with openings 176 formed in guide block 124 and may receive a portion of positioning pin 146 as slider element 112 moves in the direction (D) to traverse tip section 104B of electrode 100B through component 10 to form curved hole 150.

FIG. 25 shows a non-limiting example of a turbine blade 178 used within a power system (e.g., turbine system, combined cycle power plant and the like) (not shown). Turbine blade 178 may include a shank 180, a platform 182 positioned and/or formed radially above shank 180, and an airfoil 184 positioned and/or formed above platform 182. In the non-limiting example shown in FIG. 25, airfoil 184 may be circumferentially swept, and may include an overhanging trailing edge 186, positioned axially opposite a leading edge 188. At least a portion of trailing edge 186 may overhang and/or extend axially over and/or beyond platform 182 of blade 178.

Additionally as shown in FIG. 25, airfoil 184 of blade 178 may include a plurality of cooling channels, which may be formed as linear recess 158 and curved hole 150. That is, because of the circumferential sweep and/or overhanging trailing edge 186 of airfoil 184, cooling channels may be formed, at least in part, from curved hole 150. Specifically, curved hole 150 may form a portion of the cooling channels within the portions of airfoil 184 that are not substantially linear (e.g., circumferential swept), and/or where a linear cooling channel cannot be adequately or desirably formed. For example, linear recess 158 may be formed and/or extend from tip 190 of airfoil 184 and partially through airfoil 184. Linear recess 158 may be formed only through a portion of airfoil 184 that is substantially linear and/or may allow linear recess 158 to be formed within. As shown in FIG. 25, curved hole 150 may be formed adjacent to and/or in communication with linear recess 158 and may extend radially and axially through airfoil 184 to platform 182. In this non-limiting example, curved hole 150 may be formed and/or extend from a portion of linear recess 158 adjacent tip section 190 and may extend axially toward overhanging trailing edge 185 of airfoil 184. Additionally, curved hole 150 may be formed to extend radially toward platform 182 of blade 178, and intersect linear recess 158 adjacent second opening 154. In the non-limiting example shown in FIG. 25, curved hole 150 may be formed close to and/or directly adjacent overhanging trailing edge 186. Additionally, curved hole 150 may also be formed, at least partially, to include a curvature that is substantially similar to the curvature of trailing edge 186. As such, curved hole 150 shown in FIG. 25 may provide a non-linear cooling channel within airfoil 184 to substantially cool the portion of air foil 184 surrounding and/or adjacent to overhanging trailing edge 186.

In another non-limiting example (not shown), cooling channels formed within airfoil 184 of blade 178 may also include curved holes extending to and/or formed adjacent to leading edge 188. Additionally, in another non-limiting example (not shown) airfoil 184 of blade 178 may include an overhanging leading edge 188 in addition to, or alternative to, overhanging trailing edge 186. In this non-limiting example, cooling channels may include curved holes extending to at least one of the overhanging leading edge 188 and/or trailing edge 186 of airfoil 184.

FIG. 26 shows a front, circumferential view of a stator vane 192 that may be used within a power system (e.g., turbine system, combined cycle power plant and the like) (not shown). Stator vane 192 may include an airfoil 194 positioned between an outer shroud 196 and an inner shroud 198. In the non-limiting example shown in FIG. 26, and similar to airfoil 184 of turbine blade 178, airfoil 194 of stator vane 192 may be circumferentially swept (e.g., into the page), and may include an overhanging trailing edge 200, positioned axially opposite an overhanging leading edge 202. At least a portion of trailing edge 200 and leading edge 202 may overhang and/or extend axially over and/or beyond outer shroud 196 and inner shroud 198, respectively.

In the non-limiting example shown in FIG. 26, and similar to turbine blade 178 discussed herein, stator vane 192 may include cooling channels formed within airfoil 194. Specifically, airfoil 194 of stator vane 192 may include cooling channels formed by curved holes 150A, 150B. As shown in FIG. 26, first curved hole 150A may form a cooling channel formed adjacent to overhanging trailing edge 200. First curved hole 150A may be formed through airfoil 194 and may include a geometry and/or curvature that is substantially similar and corresponds to the geometry and/or curvature of overhanging trailing edge 200. First curve hole 150A may include a first opening 152A formed adjacent outer shroud 196, and a second opening 154A formed adjacent inner shroud 198.

Additionally as shown in FIG. 26, second curved hole 150B may form at least a portion of a cooling channel formed adjacent to overhanging leading edge 202. Similar to first curved hole 150A and overhanging trailing edge 200, second curved hole 150B may include a geometry and/or curvature that is substantially similar and corresponds to the geometry and/or curvature of overhanging leading edge 202. Second curved hole 150B may be formed between outer shroud 196 and inner shroud 198. In the non-limiting example shown in FIG. 26, and distinct from the cooling channel of stator vane 192 formed using first curved hole 150A, the cooling channel partially formed by second curved hole 150B may also include a first linear recess 158A formed through outer shroud 196, and a second linear recess 158B formed through inner shroud 198. Second curved hole 150B may be in communication with first linear recess 158A and second linear recess 158B, respectively. As a result of the cooling channel of stator vane 192 including first linear recess 158A and second linear recess 158B formed in respective shrouds 196, 198, first opening 152B may be formed through outer shroud 196, and second opening 154B may be formed through inner shroud 198.

The technical effect is to provide shaped-tube electrochemical machining (STEM) systems including electrodes with angled tip sections that are capable of forming curved holes within components.

Several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or, for example, the flow of air through the combustor or coolant through one of the turbine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or turbine end of the engine. Additionally, the terms “leading” and “trailing” may be used and/or understood as being similar in description as the terms “forward” and “aft,” respectively. It is often required to describe parts that are at differing radial, axial and/or circumferential positions. The “A” axis represents an axial orientation. As used herein, the terms “axial” and/or “axially” refer to the relative position/direction of objects along axis A, which is substantially parallel with the axis of rotation of the turbine system (in particular, the rotor). As further used herein, the terms “radial” and/or “radially” refer to the relative position/direction of objects along an axis “R” (see, FIGS. 25 and 26), which is substantially perpendicular with axis A and intersects axis A at only one location. Finally, the term “circumferential” refers to movement or position around axis A (e.g., axis “C”).

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A shaped-tube electrochemical machining (STEM) system, comprising:
a slider element;
an electrode coupled to and extending from the slider element, the electrode including:
a linear body section, and
a tip section formed at a distal end of the electrode, adjacent the body section, the tip section angled at a non-linear angle relative to the linear body section;
a guide block slidably engaging the linear body section of the electrode, the guide blocking including:
a first section,
a second section releasably coupled to the first section, and
at least one aperture formed between the first section and the second section, the at least one aperture receiving the linear body section of the electrode; and
an electrode positioning block coupled to the linear body section of the electrode between the slider element and the guide block, the electrode positioning block positioning the tip section of the electrode at a desired orientation relative to a component receiving the tip section of the electrode to form a curved hole in the component.

2. The STEM system of claim 1, wherein an end of the electrode positioning block is oriented at the desired orientation relative to the component and is coplanar with the tip section of the electrode.

3. The STEM system of claim 1, further comprising:
an electrode positioning pin coupled to one of the slider element or the guide block, the electrode positioning pin positioned adjacent and contacting the electrode positioning block.

4. The STEM system of claim 3, wherein the electrode positioning block statically contacts the electrode positioning pin coupled to the slider element.

5. The STEM system of claim 4, wherein the first section of the guide block includes at least one recess for receiving the electrode positioning pin.

6. The STEM system of claim 3, wherein the electrode positioning block slidably engages the electrode positioning pin coupled to the guide block.

7. The STEM system of claim 1, wherein the tip section of the electrode is substantially linear.

8. The STEM system of claim 1, wherein the tip section of the electrode is substantially curved.

9. The STEM system of claim 1, wherein the tip section of the electrode includes:
a predetermined length; and
a predetermined non-linear angle relative to the linear body section, the predetermined non-linear angle and the predetermined length based on a desired curvature geometry for a curved hole formed in the component using the electrode.

10. The STEM system of claim 1, further comprising:
a distinct electrode interchangeable with the electrode, the distinct electrode including:
a linear body section; and
a tip section formed at a distal end of the distinct electrode, adjacent the linear body section of the distinct electrode, the tip section of the distinct electrode linearly aligned with the linear body section of the distinct electrode.

11. A method of forming a curved hole in a component using a shaped-tube electrochemical machining (STEM) system, the method comprising:
coupling an electrode positioning block of the STEM system to a linear body section of an electrode, the electrode including:
the linear body section, and
a tip section formed at a distal end of the electrode, adjacent the linear body section, the tip section angled at a non-linear angle relative to the linear body section;
coupling the electrode of the STEM system to a slider element of the STEM system;
positioning the linear body section of the electrode through an aperture of a guide block of the STEM system, the guide block positioned adjacent the electrode positioning block and opposite the slider element;
positioning the tip section of the electrode at a desired orientation relative to the component using the electrode positioning block; and
traversing the tip section of the electrode through the component to form the curved hole within the component during operation of the electrode of the STEM system.

12. The method of claim 11, wherein positioning the tip section of the electrode at the desired orientation relative to the component using the electrode positioning block further includes:
coupling an electrode positioning pin of the STEM system to the slider element of the STEM system; and
positioning the electrode positioning block to contact the electrode positioning pin,
wherein an end of the electrode positioning block contacting the electrode positioning pin is oriented at the desired orientation relative to the component and is coplanar with the tip section of the electrode.

13. The method of claim 12, wherein traversing the tip section of the electrode through the component to form the curved hole within the component further includes:
positioning the electrode positioning block to statically contact the electrode positioning pin;
moving the slider element and the electrode positioning pin toward the guide block; and
positioning at least a portion of the electrode positioning pin coupled to the slider element in a recess formed in the guide block.

14. The method of claim 12, further comprising:
uncoupling the electrode positioning pin of the STEM system from the slider element of the STEM system subsequent to positioning the electrode positioning block to contact the electrode positioning pin, and prior to traversing the tip section of the electrode through the component to form the curved hole within the component during operation of the electrode of the STEM system.

15. The method of claim 11, wherein positioning the tip section of the electrode at the desired orientation relative to the component using the electrode positioning block further includes:
coupling an electrode positioning pin of the STEM system to the guide block of the STEM system; and
positioning the electrode positioning block to contact the electrode positioning pin,
wherein an end of the electrode positioning block contacting the electrode positioning pin is oriented at the desired orientation relative to the component and is coplanar with the tip section of the electrode.

16. The method of claim 15, wherein traversing the tip section of the electrode through the component to form the curved hole within the component further includes:
positioning the electrode positioning block to slidably engage the electrode positioning pin.

17. The method of claim 11, further comprising:
stopping operation of the tip section of the electrode partially through the component to form a first portion of the curved hole within the component;
removing the tip section of the electrode from the component;
replacing the electrode of the STEM system with a unique electrode, the unique electrode distinct from the electrode and including:
a linear body section, and
a tip section formed at a distal end of the unique electrode, adjacent the linear body section, the tip section angled at a non-linear angle relative to the linear body section;
positioning of the tip section of unique electrode to a distinct, desired orientation relative to the component using the electrode positioning block coupled to the unique electrode, the distinct desired orientation distinct from the desired orientation of the tip section of the electrode;
positioning the tip section of the unique electrode directly adjacent an end point of the first portion of the curved hole formed within the component; and
traversing the tip section of the unique electrode, positioned at the distinct, desired orientation, through the component to form a second portion of the curved hole adjacent to and in communication with the first portion of the curved hole during operation of the unique electrode of the STEM system,
wherein the second portion of the curved hole has a distinct curve direction than the first portion of the curved hole.

18. The method of claim 11, further comprising:
prior to positioning the linear section of the electrode of the STEM system through the aperture of the guide block of the STEM system, positioning a distinct electrode of the STEM system through the aperture of the guide block of the STEM system,
wherein the distinct electrode of the STEM system includes:
a linear body section, and
a tip section formed at a distal end of the distinct electrode, the tip section of the distinct electrode linearly aligned with the linear body section of the distinct electrode;
traversing the tip section of the electrode through the component to form a linear recess within the component during operation of the electrode of the STEM system; and
removing the distinct electrode of the STEM system from the aperture of the guide block of the STEM system.

19. The method of claim 18, wherein traversing the tip section of the electrode through the component to form the curved hole within the component further includes:
inserting the tip section of the electrode into the linear recess formed within the component;
positioning the tip section of the electrode directly adjacent an end point of the linear recess; and
traversing the tip section of the electrode through the component to form the curved hole adjacent to and in communication with the linear recess during operation of the electrode of the STEM system.

20. The method of claim 19, further comprising:
adjusting the position of the tip section of the electrode to a distinct, desired orientation relative to the component using the electrode positioning block, the distinct desired orientation distinct from the desired orientation;
positioning the tip section of the electrode directly adjacent the end point of the linear recess and a beginning of the curved hole formed within the component; and
traversing the tip section of the electrode, positioned at the distinct, desired orientation, through the component to form a distinct curved hole adjacent to and in communication with the curved hole and the linear recess during operation of the electrode of the STEM system,
wherein the distinct curved hole has a distinct curve direction than the curved hole.
